(19) United States
(12) Patent Application Publication
(10) Pub. No.: US 2008/0056950 A1
(43) Pub. Date: Mar. 6, 2008

(54) DEVICE FOR THE DETECTION OF FLUORESCENCE EMITTED BY CHROMOPHORIC ELEMENTS IN THE WELLS OF A MULTIWELL PLATE

(75) Inventors: Claude Weisbuch, Paris (FR); Maxime Rattier, Paris (FR); Georges Olivier Reymond, Orsay (FR); Houtai Choumane, Paris (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Genewave

(21) Appl. No.: 11/627,043

(22) Filed: Jan. 25, 2007

Related U.S. Application Data
(63) Continuation of application No. PCT/FR2005/001928, filed on Jul. 25, 2005.

(30) Foreign Application Priority Data
Jul. 26, 2004 (FR) 0408245

(51) Int. Cl. G01N 21/01

(52) U.S. Cl. 422/82.11

(57) ABSTRACT

A device for detecting the fluorescence emitted by chromophore elements contained in the wells of a multiwell plate, the device comprising means integrated in the transparent bottoms of the wells of the plate to limit the penetration length in the wells of a light beam for exciting chromophore elements fixed on the bottoms of the wells.

### CROSS-REFERENCE TO RELATED APPLICATIONS

This is a continuation of International Application PCT/FR2005/01928 filed Jul. 25, 2005, which claims priority from French Application No. 0408245 filed Jul. 26, 2004.

The invention relates to a device for detecting the fluorescence emitted by chromophore elements contained in the wells of a multiwell plate of the type used in biology and in pharmacology.

These standardized plates have a large number of wells in a matrix disposition and they can be handled by robots which place therein determined quantities of liquids for reactions involved in sample assay, DNA hybridization, etc.

The cells or molecules of biological interest contained in these wells can be marked specifically by chromophore elements that emit fluorescence over a narrow band of wavelengths in response to light excitation in another narrow band of wavelengths, the emitted fluorescence serving to reveal the marked cells or molecules, or some of their properties. For example, it is possible to detect an antibody at the surface of cells that are selected on the basis of the quantity of fluorescent markers they have captured (screening technique). It is also possible to hybridize marked DNA strands on known complementary strands fixed to the bottoms of wells in a multiwell plate. Under all circumstances, it is necessary to determine a quantity of fluorescent markers fixed to the bottoms of wells.

To do this, in a known technique, the bottoms of the wells are made of transparent material, thus making it possible to excite the fluorescent markers by means of a light beam passing through the bottoms of the wells, and a scanning confocal microscope is used to excite a point on the bottom of a well and pick up the fluorescence emitted by said point, using a very small depth of field so as to isolate said point from nearby points in the well.

The scanning makes it possible to build up point-by-point an image of the inside surface of the bottom of the well or of a central zone of said surface. The fluorescent markers present in large number in the liquid contained in the well determine a background level for the image, relative to which the fluorescent markers of the cells or molecules fixed on the bottom of the well form easily-identifiable spots.

That scanning confocal microscopy technique serves effectively in separating the markers of cells or molecules fixed on the bottoms of the well from markers that are in suspension in the liquid contained within the wells, however it is expensive and very slow.

An object of the invention is to provide a device for detecting the fluorescence emitted by chromophore elements or markers fixed on the transparent bottoms of wells in a multiwell plate, the device not presenting the drawbacks of expense and slowness of scanning confocal microscopy, while conserving its advantages in terms of selectivity.

To this end, the invention provides a device for detecting the fluorescence emitted by chromophore elements contained in wells of a multiwell plate, the device comprising means for exciting the chromophore elements by a light beam passing through the transparent bottoms of the wells, means for limiting the zone in each well through which the excitation light beam passes to a thin layer situated on the transparent bottom of the well, so as to excite only those chromophore elements that are present in said thin layer, and means for picking up through said bottoms the fluorescence emitted by the chromophore elements in response to said excitation, the device being characterized in that the transparent bottom of each well includes on its inside face a waveguide whose core contains components that emit radiation in response to light excitation, the emitted radiation being at the excitation wavelength of the above-mentioned chromophore elements.

The bottoms of the wells are thus illuminated by radiation at the excitation wavelength of the emitter components of the waveguide, which radiation is directed towards the waveguide through the transparent bottoms of the wells.

The light radiation for exciting the chromophore elements is emitted by the above-mentioned components of the waveguide and propagates in a guided mode that is very selective in three-dimensional space and that excites only those chromophore elements that are situated in the immediate vicinity of the waveguide.

Advantageously, a peripheral portion of the waveguide in each well is covered in an opaque layer, and a layer of transparent material is interposed between the waveguide and said opaque layer.

Preferably, the central portion of the waveguide in each well does not include the above-mentioned components that emit the light radiation for exciting the chromophore elements.

The refractive indices of the various layers used are selected so that the refractive index of the transparent bottom of each well is preferably less than the refractive index of the liquid contained in the well, the core of the waveguide necessarily having a refractive index greater than both those indices, but low enough to ensure that the guided wave penetrates effectively into the liquid.

In this embodiment, the various elements can be made of plastics material or by a sol-gel technique. The components included in the waveguide for emitting at the excitation wavelength of the chromophore elements may be organic molecules of the kind used in dye lasers and in organic light-emitting diodes (LEDs), or they may be the fluorophores that are usual in biology. It is also possible for these emitter components to be constituted by inorganic materials such as quantum dots or rare earths.

The bottoms of the wells of the microplates may be made by etching, embossing, stamping, pressing, molding, or machining the above-mentioned layers. When the central zone of the waveguide in each well does not include organic molecules forming the emitter components, it is possible to start from a waveguide that contains said organic molecules over its entire area and then to illuminate it locally in ultraviolet light or in intense light in order to destroy the organic molecules that are to be found in the central zones of the bottoms of the wells.

According to another characteristic of the invention, the device includes a set of photodetectors of the charge-coupled device (CCD) type, the complementary metal oxide on silica (CMOS) type, or like type, and image-forming means mounted between the plate and the set of photodetectors in order to form on said set of detectors the image of the transparent bottoms of a plurality of wells.

The field of the image-forming means and the size of the set of photodetectors can be a few centimeters, thus making it possible to reconstitute the image of an entire multiwell plate from a few images provided by the set of photodetectors. Such reconstruction requires a mechanism to be used that need only be of low precision in order to position the multiwell plate relative to the set of photodetectors and provide images that overlap. The resolution and the precision of the images depend only on the precision and the performance of the set of photodetectors. Furthermore, this set of photodetectors and the associated image-forming means may advantageously be constituted by an imaging system of a convertional type of digital camera of the kind that is commercially available, or of a scientific digital motion-picture camera.

The device may also include a set of optical fiber bundles extending between the transparent bottoms of the wells of the plate and the image-forming means, each bundle of optical fibers in the set having a first end placed facing a transparent bottom of a well, and a second end placed facing the image-forming means, the second ends of the optical fiber bundles being combined to form a single bundle facing the image-forming means.

Each bundle of fibers may comprise a few hundreds of fibers covering an area of a few square millimeters. By using a sufficient number of bundles of fibers, it is possible to form directly on the set of photodetectors a composite image of the transparent bottoms of all of the wells in a multiwell plate. In a variant, an image of a fraction of the wells of the plate is formed on the set of photodetectors, and then the plate is moved relative to the set of photodetectors in order to reconstitute a complete image from a plurality of different images that are juxtaposed.

In any event, the images of the transparent bottoms of the wells in a multiwell plate are acquired much more quickly than in the prior art technique of scanning confocal microscopy.

Means may optionally be placed in the wells of the plate in order to limit the zone through which the beam for exciting the chromophore elements passes, such as, for example, an opaque liquid contained in the well of the plate that limits the penetration length of the excitation beam to a value that is typically shorter than 100 micrometers (μm), and for example lies in the range 1 μm to 10 μm.

The liquid may be made opaque by adding an opaque compound that is liquid or indeed soluble or even that forms an opaque suspension or emulsion together with the above-mentioned liquid, or else it may be a solid compound in powder form that settles to form an opaque layer deposited on the bottoms of the wells.

The compound used may be milk, which has the advantage of being biocompatible with the contents of the wells of the plate, or a paint, or an ink, or it may equally be a fine sand compound, very fine silica or alumina powder, carbon black, glass microbeads, or a colloid.

In general, the compound that opposes penetration of the light beam for exciting the chromophore elements may be white, i.e. non-absorbent, or colored, e.g. so as to absorb specifically the excitation wavelength of the chromophore elements, or indeed the wavelength at which fluorescence is emitted by the chromophore elements in response to the excitation, or it may be black so as to absorb all light radiation.

When the compound is white, the back-scattering by the compound of the excitation light beam leads to an increase in the excitation of the chromophore elements and thus to an increase in the amount of fluorescence emitted, which emitted fluorescence is itself back-scattered towards the above-mentioned pick-up means.

When the compound is colored or black, care is taken to ensure that the absorption of the light radiation for exciting the chromophore elements does not lead to parasitic emission by the compound at the wavelength of the fluorescence emitted by the chromophore elements, so as to avoid falsifying measurements.

In another embodiment, the opaque means placed in the wells for limiting the penetration of the light beam for exciting the chromophore elements may comprise a screen that is placed or deposited on the bottom of each well and that covers said bottom at least in part.

Advantageously, the screen is associated with means enabling it to be moved in the well between an active position and an inactive position, for example the various screens may be carried by a lid for the multiwell plate.

In practice, each screen may comprise a solid plate, or else a lattice or a three-dimensional mesh of wires or fibers of an opaque material, such as a plastics material which may be white, colored, or black.

The invention can be better understood and other characteristics, details, and advantages thereof appear more clearly on reading the following description, made by way of example and with reference to the accompanying drawings, in which:

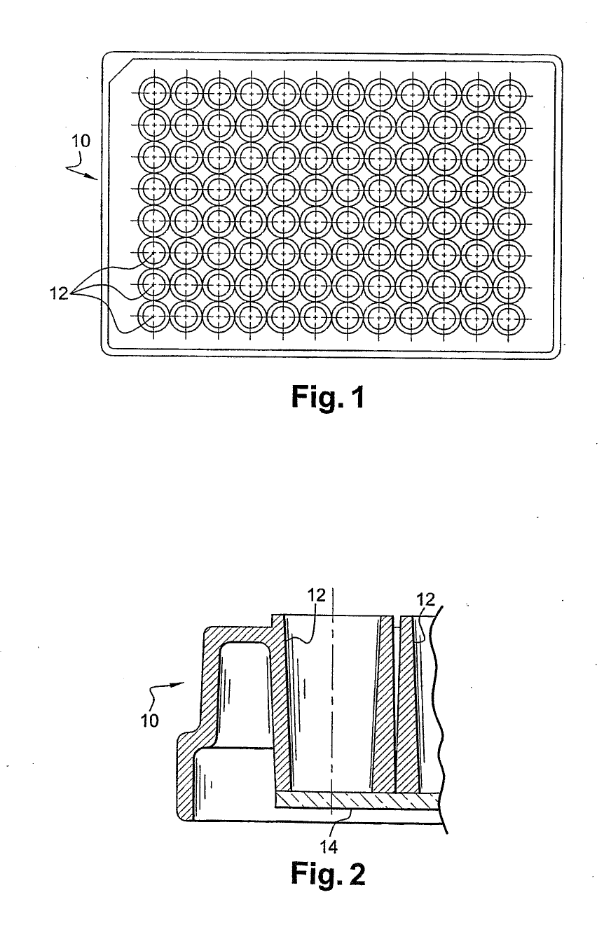

FIG. 1 is a diagrammatic plan view of a multiwell plate of a standardized type;

FIG. 2 is a diagrammatic view on a larger scale and in section of a portion of said plate;

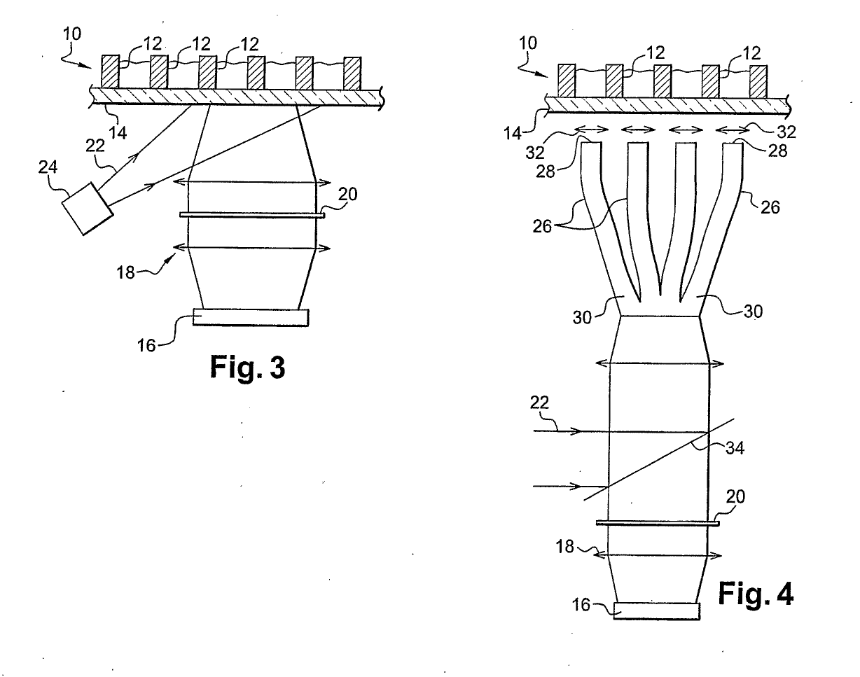

FIGS. 3 and 4 are diagrams showing means for picking up the fluorescence emitted by chromophore elements situated on the bottoms of the wells in the above plate;

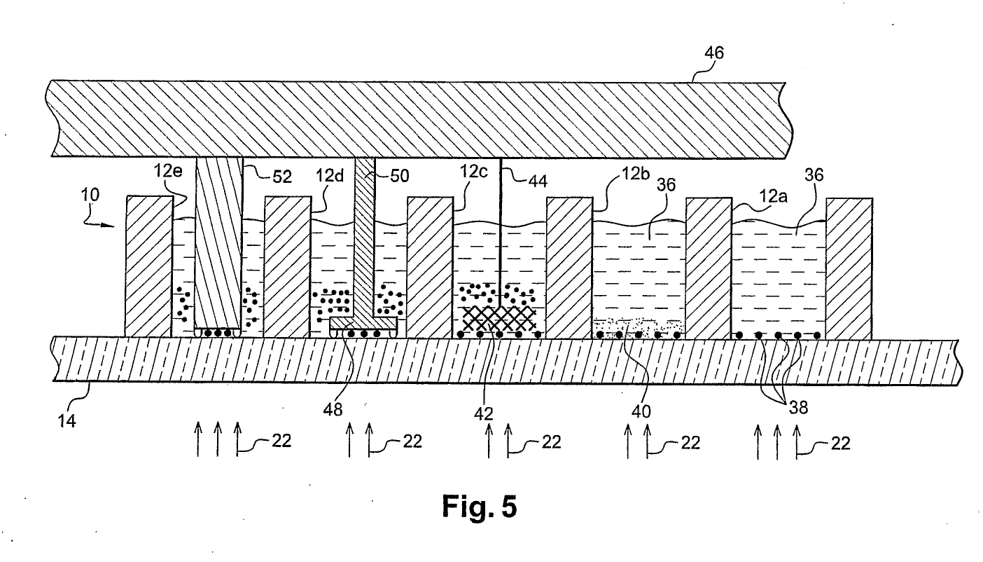

FIG. 5 is a diagram showing opaque means placed in the wells of the plate to limit the penetration length of the radiation for exciting the chromophore elements; and

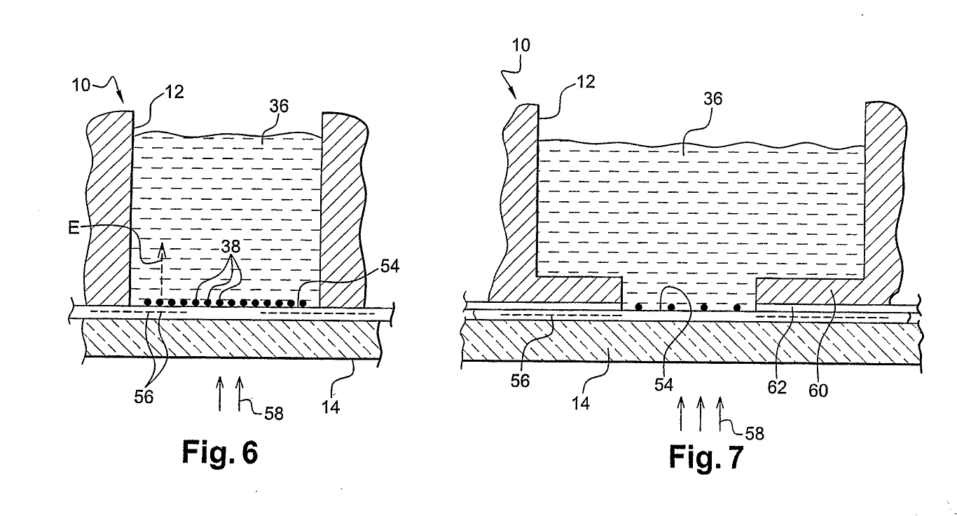

FIGS. 6 and 7 are diagrams showing means integrated in the bottoms of the wells to limit the penetration length of the radiation for exciting the chromophore elements.

FIGS. 1 and 2 are diagrams of a multiwell plate 10 of standardized type in very widespread use in biology and pharmacology, said plate 10 being made of molded plastics material and having a large number of wells 12 in a matrix disposition, the wells being closed at their bottom ends by a fitted plate 14 of transparent material, e.g. of plastics material, of glass, or of quartz.

In a variant, the plate 10 may be molded as a single piece of transparent plastics material.

In the example shown, the plate 10 has 96 wells which, depending on the implementation, typically present an inside diameter lying in the range 5 millimeters (mm) to 8 mm, a depth lying in the range 1 mm to 10 mm, and spaced apart from one another by a distance equal to 2.25 mm or 4.5 mm or 9 mm, the wells 12 being cylindrical or slightly tapering, as shown diagrammatically in FIG. 2.

These standardized plates are handled by robots that place predetermined quantities of liquids (samples, reagents, washing and rinsing solutions, etc.) in the wells 12 in order to perform enzymatic or immunological assaying reactions, DNA hybridization, etc.

Cells or molecules of biological interest contained in the wells 12 are fixed on the bottoms of the wells, i.e. on the transparent plate 14 and they are identifiable by exciting fluorescent markers that they include or that are fixed to said cells or molecules. These markers may be of various types and are referred to below by the generic term “chromophore elements”.

In practice, it generally suffices to detect and count the chromophore elements that are to be found in a central zone at the bottom of each well 12, said central zone typically having a radius of millimeter order.

Chromophore elements of interest are excited by being illuminated at a determined wavelength through the transparent bottoms of the wells 12. It is necessary to detect and pick up the fluorescence emitted by the chromophore elements of interest while ignoring that emitted by the very large number of chromophore elements in suspension in the liquid contained in the wells 12, such detection and picking up thus needing to be particularly selective.

The detection and pick-up means shown diagrammatically in FIG. 3 comprise a set 16 of photodetectors of the CCD, CMOS, or like type, preferably in a matrix disposition and placed under the transparent bottom 14 of the plate 10, the set 16 of photodetectors having dimensions that are, for example, a few square centimeters and being associated with image-forming means 18 enabling the image of a plurality of well bottoms in the plate 10 to be formed on the set 16 of photodetectors. An optical filter 20 is arranged in the image-forming means 18 so as to pass only a narrow band of wavelengths centered on the wavelength of the fluorescence emitted by the chromophore elements fixed on the transparent bottoms of the wells 12. Said wavelengths then reach the set 16 of photodetectors.

Advantageously, the set 16 of photodetectors and the image-forming means 18 form parts of a conventional digital camera of the kind that is commercially available, or of a scientific digital motion-picture camera.

The group of transparent well bottoms whose image is formed on the set 16 of photodetectors is illuminated at the excitation wavelength of the chromophore elements by a light beam 22 generated by a source 24 such as a laser, a laser diode, a LED, or any other suitable generator.

Preferably, the source 24, the set 16 of photodetectors, and the image-forming optical means 18, 20 are mounted as a fixed station with the plate 10 being carried on a suitable support (not shown) that is movable horizontally in two perpendicular directions so as to move the bottoms of the wells 12 over the fluorescence detection and pick-up means so as to enable a complete image of the bottoms of the wells 12 of the plate to be built up from a few images provided by the set 16 of photodetectors.

Advantageously, software serves to select from the images provided by the set 16 of photodetectors those zones that correspond to the central portions of the transparent bottoms of the wells 12 and to treat only the images of said central zones.

The system shown diagrammatically in FIG. 3 presents the advantage of depending neither on the type nor on the format of the plate 10 used, and of enabling images to be acquired very quickly of the portions of interest of the transparent bottoms of the wells 12 in a plate.

The means used for moving the plate 10 relative to the set 16 of photodetectors can be automated in simple manner and can operate with low precision, of the order of one millimeter. They are thus simple and inexpensive to make.

In the embodiment shown diagrammatically in FIG. 4, the set 16 of photodetectors and the image-forming means 18, 20 placed under the plate 10, are associated with a set of optical fiber bundles 26 having first ends 28 spaced apart from and pointing towards the transparent bottoms of the wells 12 of the plate 10, and having second ends combined to form a single bundle pointing towards the image-forming means 18, 20 and the set 16 of photodetectors.

Each bundle 27 of optical fibers may comprise several thousand optical fibers whose first ends are spaced apart from one another by a small distance, and are distributed over an area of a few square millimeters. Thus, each end 28 of an optical fiber bundle can be aligned on a central zone of a transparent bottom of a well 12 in the plate 10 so as to form an image of said zone on a portion of the set 16 of photodetectors. Focusing lenses 32 are arranged between the bottoms of the wells 12 and the first ends 28 of the bundles 26 of optical fibers.

When the transparent bottoms of the wells 12 are illuminated to excite the chromophore elements of interest by means of a light beam 22 that is caused to travel along the bundle 26 of optical fibers, a beam splitter 34 is placed in the image-forming means 18 between the filter 20 and the second ends 30 of the bundles 26 of optical fibers.

The number of bundles 26 of optical fibers may be sufficient to form directly and simultaneously on the set 16 of photodetectors a complete image of the transparent bottoms of the wells 12 of the plate 10.

In a variant, the set of bundles 26 of optical fibers is used to form on the set 16 of photodetectors only the image of some of the transparent bottoms of the wells 12 of the plate 10, and then the plate is moved horizontally over the bundles 28 of optical fibers, as described above for the embodiment of FIG. 3, so as to reconstitute a complete image of the bottoms of the wells 12 of the plate from a plurality of images delivered by the set 16 of photodetectors. As shown in FIG. 3, the bottoms of wells are then illuminated by a light beam 22 external to the bundles 28 of optical fibers.

FIG. 5 shows a plurality of means that can be placed in the wells 12 in order to limit the penetration length of the beam 20 for exciting the chromophore elements.

In a first embodiment, the liquid 36 contained in the well 12a of the plate 10 is made opaque to the beam 22 for exciting the chromophore elements 38 by adding a suitable compound to the liquid, which may take a very wide variety of forms.

The compound may be liquid or soluble, inert or biocompatible with the cells or strands of DNA contained in the well 12a, and it is added to the well at the same time as the chromophore elements 38. It may form a suspension or an emulsion in the liquid 36.

It can be constituted, for example, by an ink, a paint, a hydrolysate of proteins or of milk, with the concentration and the characteristics of the compound being determined so that the penetration length of the excitation beam 22 in the liquid 36 from the transparent bottom 14 of the well 12a is less than about 100 μm, and preferably about 5 μm so as to excite only the chromophore elements 38 of interest that are fixed on the transparent bottom of the well 12a. For example, a concentration of 10 grams per liter (g/L) to 100 g/L of powdered skim milk or of carbon black is appropriate.

The liquid 36 that is made opaque by the compound may be white, i.e. non-absorbent, or colored so as to absorb specifically a wavelength corresponding to excitation of the chromophore elements 38, or to the fluorescence emitted by the chromophore elements, or indeed it can be black so as to absorb all wavelengths.

Since the penetration length of the excitation beam 22 in the liquid is very small, and for example of the same order of magnitude as the thickness of a cell (about 1 μm), the chromophore elements contained in the liquid 36 above the transparent bottom of the well 12a are not excited, and the means for picking up the fluorescence through the transparent bottom 14 receives only fluorescence emitted by the chromophore elements of the cells or molecules of interest that are fixed on the bottom of the well.

In a variant, a solid powder compound is added to the liquid 36 contained in the well 12b that does not dissolve but that settles on the bottom of the well so as to form an opaque layer covering the cells fixed on the bottom of the well in part or completely.

The compound may be fine sand, a very fine powder of silica or alumina, carbon black, a colloid, microbeads of glass, or the like. It may be diffusing, colored, or reflective.

When the compound is white, back-scattering of the light 22 for exciting the chromophore elements leads to an increase in said excitation, and thus to an increase in the fluorescence emitted, which is itself back-scattered towards the above-mentioned pick-up means.

When the compound is colored or black, care is taken to ensure that the absorption of the excitation light 22 does not lead to parasitic emission at the wavelength of the fluorescence emitted by the chromophore elements 38.

In another embodiment, a lattice, a sintered piece of glass or of metal, or a three-dimensional mesh 42 of wires or fibers of an opaque material is deposited on the transparent bottom of the well 12c to limit the penetration length of the light 22 for exciting the chromophore elements 38. The lattice, sintered piece, or mesh 42 allows the liquid 36 to flow, while forming a screen that is opaque to propagation of the excitation light 22. The lattice or mesh is preferably made of a plastics material that may be white, black, or colored.

This lattice, sintered piece, or mesh 42 is advantageously connected by a rigid rod 44 to a lid 46 placed on top of the plate 10.

In another embodiment, the means placed in the well 12d for limiting propagation of the excitation light 22 are formed by a piston 48 having a rod 50 secured to the above-mentioned lid 46 and having an opaque bottom surface that may be white in order to back-scatter light, or else black or indeed reflective by having a mirror indicated therein, e.g. constituted by a metal layer protected by a layer of plastics or dielectric material, the mirror possibly also being made as a stack of dielectric layers or indeed as a layer of plastics material. The bottom end of the piston 48 has fingers or projections acting as a spacer and enabling the bottom face of the piston to be placed at a predetermined distance from the transparent bottom of the well 12d, which distance is of the order of 10 μm, for example.

In yet another embodiment, the means placed in the well 12e are formed by a cylinder 52 carried by the lid 46 and having its bottom end including point or almost point support means for engaging the transparent bottom of the well 12e so as to leave a thin layer of liquid between the bottom end of the cylinder 52 and the transparent bottom 14 of the well 12e, this thin layer having a thickness of about 10 μm, for example.

As described above for the piston 48, the bottom face of the cylinder 52, which is opaque to the excitation light 22, may be white, colored, black, or reflecting.

FIGS. 6 and 7 show the means which, according to the invention, are integrated in the bottoms of the wells 12 for limiting the penetration length into said wells of the light for exciting the chromophore elements.

In the embodiment of FIG. 6, the transparent plate 14 forming the bottoms of the wells 12 includes, on its face situated inside the wells, a waveguide 54 whose core contains chromophore components 56 different from the chromophore elements 38 serving to mark the cells or the molecules. The components 56 have an excitation wavelength that is shorter than the excitation wavelength of the above-mentioned chromophore elements 38 and they have an emission wavelength that is equal to the excitation wavelength of the chromophore elements 38, which themselves emit fluorescence at a wavelength that is longer.

Thus, when the transparent bottom 14 of the well 12 in FIG. 6 is illuminated by light 58 at the excitation wavelength of the core components 56 of the waveguide 54, these components 56 emit at the excitation wavelength of the chromophore elements 38. Part of this emission is directed directly towards the liquid 36 contained in the well 12, as represented by dashed-line arrow E, and part is guided in the waveguide 54, this guided emission being very selective and exciting only the chromophore elements 38 that are on the waveguide 54 or in its intermediate vicinity, i.e. at a distance of less than 1 μm, depending on the penetration of the guided wave into the liquid 36.

The guided mode corresponds to a significant fraction of the light emitted by the components 56, which fraction is generally greater than 10%.

Advantageously, provision is made for the central portion of the waveguide 54 in the well 12 not to contain emitter components 56, this central portion typically having a radius of about 1 millimeter. The direct emission E at the excitation wavelength for the chromophore elements 38 thus involves only the peripheral portion of the waveguide in the well 12, and illuminates the central zone of the well only marginally, while the guided wave within the waveguide 54 reaches the central zone of the waveguide and excites the chromophore elements 38 that are fixed on said central portion or that are immediately adjacent thereto.

In the embodiment of FIG. 7, the peripheral surface of the waveguide 54 in the well 12 is masked by an annular layer 60 of opaque material that stops the direct light emission by the emitter components 56 contained in the core of the waveguide. A transparent layer 62 separates the waveguide 54 from the opaque annular layer 60 so as to avoid absorbing the guided wave.

The waveguide 54, the transparent layer 62, and the opaque layer 60 are preferably made of plastics materials or are implemented by a sol-gel technique. The emitter components 56 may be organic components of the kind used in dye layers (rhodamine, coumarin), in organic LEDs (copolymers such as Alq3), or ordinary fluorophores such as cyanine-3, cyanine-5, or alexa. It is also possible to use inorganic materials such as quantum dots or rare earths for the emitter components 56.

The refractive index of the transparent bottom 14 is preferably less than that of the liquid 36, and the core of the waveguide 54 must have an index greater than those of the bottom 14 and of the liquid 36. It is also necessary for the refractive index to be relatively low so as to ensure good penetration of the guided wave into the liquid 36. The effective index is selected so as to obtain optimum penetration corresponding to the thickness of one cell (about 1 μm) or of one molecule (thickness less than 0.1 μm). The thickness of the guiding layer is about 1 μm and it is selected to ensure good absorption of the excitation light 58 and to constitute a waveguide having a small number of modes, preferably only one mode.

The various above-mentioned layers may be etched, embossed, stamped, pressed, molded, or machined.

In order to ensure that the central zone of the waveguide 54 in each well 12 does not include emitter components, it is advantageous to use organic molecules as the emitter components and to eliminate them locally from the waveguide 54 by exposure to ultraviolet light or to intense light.

The embodiment of FIG. 7 can advantageously be made with multiwell plates in which the bottoms are opaque, each including an opening having a diameter of about 2 mm, for example. It then suffices to stick a composite plastics film on the bottoms of the wells, which film contains the waveguide together with the emitter components formed by organic molecules, and then to illuminate the wells with ultraviolet light so as to destroy the emitter components that are located within the holes in the bottoms of the wells.

In a particular embodiment, the refractive index of the transparent bottom 14 of the wells is equal to 1.3, that of the liquid 36 is equal to 1.35, and that of the core of the waveguide 54 is equal to 1.4. In a variant, the refractive index of the bottom 14 is equal to 1.4, that of the liquid 36 is equal to 1.35, and that of the core of the waveguide is equal to 1.45. The multiwell plate is made of polystyrene, polypropylene, polyvinyl chloride, or acrylic polymer. The multilayer composite suitable for use in the embodiments of FIGS. 6 and 7 is made of glass, of quartz, or of dielectric transparent materials, or of plastics material such as polystyrene, polypropylene, polyvinyl chloride, an acrylic polymer, polyethylene, polycarbonate, or a polyolefin in general.

1. A device for detecting the fluorescence emitted by chromophore elements contained in wells of a multiwell plate, the device comprising means for exciting the chromophore elements by a light beam passing through the transparent bottoms of the wells, means for limiting the zone in each well through which the excitation light beam passes to a thin layer situated on the transparent bottom of the well, so as to excite only those chromophore elements that are present in said thin layer, and means for picking up through said bottoms the fluorescence emitted by the chromophore elements in response to said excitation, the device being characterized in that the transparent bottom of each well includes on its inside face a waveguide whose core contains components that emit radiation in response to light excitation, the emitted radiation being at the excitation wavelength of the above-mentioned chromophore elements, and in that the above-mentioned excitation means emit radiation at the excitation wavelength of the components of the wavelength, said radiation being directed towards the waveguide through the transparent bottom of the well.

2. A device according to claim 1, characterized in that the excitation wavelength of the components of the waveguide is shorter than the excitation wavelength of the above-mentioned chromophore elements.

3. A device according to claim 1, characterized in that the refractive index of the core of the waveguide is greater than the refractive indices of the bottom of the well and of the liquid.

4. A device according to claim 1, characterized in that a peripheral portion of the waveguide in each well is covered in an annular opaque layer and a layer of transparent material interposed between the waveguide and the annular layer.

5. A device according to claim 4, characterized in that the central portion of the waveguide in each well does not include the above-mentioned emitter components.

6. A device according to claim 1, characterized in that it also includes means placed in the wells to limit the zone through which the excitation light beam passes, said means being constituted by a solid screen placed or deposited on the bottom of each well and covering at least a portion of the bottom.

7. A device according to claim 6, characterized in that it includes means for moving said screens in the wells.

8. A device according to claim 6, characterized in that the screens are carried by a lid of the multiwell plate.

9. A device according to claim 6, characterized in that each screen comprises a solid plate, a lattice, a sintered piece of glass or of metal, or a three-dimensional mesh of wires or fibers of opaque material, e.g. of plastics material.

10. A device according to claim 1, characterized in that a liquid that is opaque to the light beam is contained in the wells and limits the penetration length of the excitation beam to a value that is shorter than 100 μm, e.g. lying in the range 1 μm to 10 μm.

11. A device according to claim 10, characterized in that said opaque liquid comprises milk, a paint, or an ink, fine sand, silica or alumina powder, carbon black, glass microbeads, or a colloid.

12. A device according to claim 1, characterized in that it includes a set of photodetectors of the CCD, CMOS, or like type, and image-forming means mounted between the plate and the set of photodetectors to form on said set the image of the transparent bottoms of a plurality of wells.

13. A device according to claim 12, characterized in that it also includes a set of optical fiber bundles extending between the transparent bottoms of the wells and the image-forming means, each bundle of optical fibers having a first end placed facing the transparent bottom of a well, and a second end placed facing the image-forming means, said second ends of the bundles being combined to form a single bundle.

14. A device according to claim 13, characterized in that the ends of the optical fibers of each bundle are separated from one another at the first end of each bundle, and are spaced apart from one another by a small distance, e.g. lying in the range 5 μm to 50 μm.
